(19) United States
(12) Patent Application Publication
(10) Pub. No.: US 2015/0268128 A1
(43) Pub. Date: Sep. 24, 2015

(54) Calculating Nonlinear Kerr Coefficient for a Waveguide

(71) Applicant: Canon Kabushiki Kaisha, Tokyo (JP)

(72) Inventor: Alexey V. Maslov, Tucson, AZ (US)

(73) Assignee: Canon Kabushiki Kaisha, Tokyo (JP)

(21) Appl. No.: 14/294,553

(22) Filed: Jun. 3, 2014

Related U.S. Application Data
(60) Provisional application No. 61/968,902, filed on Mar. 21, 2014.

(51) Int. Cl. G01M 11/00; G06F 17/10

(52) U.S. Cl. CPC G01M 11/30; G06F 17/10

(57) ABSTRACT

Calculating a non-linear Kerr coefficient in a waveguide. Formulating equations based on Maxwell's equations which represent propagation of an electro-magnetic wave down the waveguide based on the material properties of the waveguide and the geometry of the waveguide. Producing discretized equations. Solving the discretized equations using an eigenvalue solving technique for a set of electro-optical waves with a frequency ω and a wavenumber β in the non-linear regime and a wavenumber β₀ in the linear regime. Wherein the eigenvalue is related to the wavenumbers (β, β₀). Wherein a power P of the electromagnetic wave is related to an eigenfunction. Calculating a nonlinear Kerr coefficient γ based on (β, β₀, P).

### CROSS REFERENCE

This application claims the benefit of the U.S. provisional application No. 61/968,902 entitled “Method for Calculating the Nonlinear Kerr Coefficient for a Waveguide Using Power-Dependent Dispersion Modification” filed on Mar. 21, 2014. U.S. provisional application No. 61/968,902 is incorporated by reference herein in its entirety.

### BACKGROUND

### Field of Art

Nonlinear processes form the foundations of many optoelectronics devices. A common goal is to understand and develop methods for increasing and/or controlling these nonlinearities. This is achieved by exploring both new materials and new waveguide configurations. Examples of new materials are silica glass, SF6 glass; chalcogenide glass; sapphire; fluorozirconate; fluoroaluminate; and other glasses and crystals with a variety of dopants. Examples of new waveguides configurations are: photonic nanowires; holey fibers; photonic crystal waveguides; strip waveguides; rib waveguides; and other optical mode confining techniques. For example, the high-refractive index contrast in photonic nanowires leads to a large mode confinement and therefore, a large nonlinearity.

The development of novel nonlinear waveguiding structures requires the evaluation of their nonlinear coefficients. The nonlinear coefficient for a waveguide depends on both the material property and the guided mode. One key non-linear effect is the case of Kerr nonlinearity. A time-varying electric field modifies the refractive index of the medium proportional to the its time-average (E²).

### SUMMARY

A method for calculating a non-linear Kerr coefficient in a waveguide. The method includes receiving input parameters which describe geometry of the waveguide and material properties of the waveguide. The method includes formulating one or more or equations based on Maxwell's equations which represent propagation of an electro-magnetic wave down the waveguide based on the material properties of the waveguide and the geometry of the waveguide. The method includes discretizing the one or more equations to produce one or more discretized equations. The method includes solving the one or more discretized equations using an eigenvalue solving technique for a set of electro-optical waves with a frequency ω and a wavenumber β in the non-linear regime and a wavenumber β₀ in the linear regime. Wherein solving the one or more discretized equations produces an eigenvalue which is related to the wavenumbers (β, β₀) as described in the one or more or equations based on Maxwell's equations. Wherein a power P of the electromagnetic wave is related to an integral of a square of an absolute value of the electromagnetic wave described by an eigenfunction produced by solving the one or more discretized equations using an eigenvalue solving technique. The method includes calculating a nonlinear Kerr coefficient γ, wherein γ is described by:

$$γ = \frac{β - {β}_{0}}{P}$$

The method includes outputting the nonlinear Kerr coefficient γ.

The input parameters which describe the geometry maybe selected from: height; width; length; radius, and one or more axes of symmetry. The input parameters which describe the geometry may define one or more areas or volumes of the waveguide. Each area or volume may have different material properties. The input parameters which describe material properties input parameters may include linear refractive index, nonlinear susceptibility parameters. The input parameters which describe material properties may be functions which vary over the volume of the waveguide.

The method may include reducing the one or more or equations based on Maxwell's equations to one equation based on the symmetry of waveguide.

The method may include discretizing of the one or more equations based on Maxwell's equations includes converting the one or more equations to difference equations.

The method may include discretizing of the one or more equations based on Maxwell's equations includes converting the one or more equations to finite element equations.

The method wherein the one or more equations based on Maxwell's equations may be differential equations.

The method wherein the one or more equations based on Maxwell's equations may be integral equations.

The method wherein the solving of the one or more discretized equations comprises: solving the one or more discretized equations in the linear regime for β₀ and an electric field of the electro-optical wave; modifying a refractive index in the one or more discretized equations based on the electric field of the electro-optical wave; and solving the modified one or more discretized equations in the non-linear regime for the wavenumber β. Wherein the eigenfunction used to calculate the power P is based on solving the one or more discretized equations in the linear regime. The refractive index may be modified by calculating the power-dependent anisotropic permittivity using modal fields determined from the electric filed of the electro-optical wave.

A computer readable medium may include instructions for the method.

Further features and aspects will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments.

FIGS. 1A-B are illustrations of modes in a slab waveguide and a wire waveguide.

FIGS. 2A-B are illustrations of results of the described herein compared to other methods.

FIG. 3 is an illustration of a method of calculating the Kerr coefficient.

FIG. 4 is an illustration of a device that may implement a method of calculating the Kerr coefficient.

### DESCRIPTION OF THE EMBODIMENTS

Embodiments will be described below with reference to the attached drawings.

The development of novel nonlinear waveguiding structures requires the evaluation of their nonlinear coefficients. The nonlinear coefficient for a waveguide depends on both the material property and the guided mode. One nonlinear coefficient of great importance is Kerr nonlinearity. A time-varying electric field E modifies the refractive index of the medium n and is proportional to its time-average (E²) as stated in equation (1).

n=n₀+ n̅₂(E²) (1)

Where n₀ is refractive index in the absence of the electric field E and an optical constant n̅₂ which is function of both the material and the geometry of the waveguide. For a plane wave in the nonlinear medium, one can also represent n in terms of the intensity l which is related to the power P transmitted through an area A as described in equation (2).

$$n = {n}_{0} + {n}_{2} I = {n}_{0} + {n}_{2} \frac{P}{A} \qquad ( 2 )$$

Where n₂ is the intensity dependent refractive index which is directly related to n̅₂. Equation (2) is also applicable to wide beams of a specific polarization. As an optical wave ˜exp(−iωt+iβz), in which i is an imaginary number, ω is an optical frequency, t is time, β is the wavenumber, and z is the position along the propagation axis of the waveguide. As the wave propagating along a nonlinear waveguide induces a change in the waveguides refractive index and the wavenumber β becomes power dependent. This power dependence can be described in equation (3) in terms of a nonlinear coefficient γ and β₀ describes the linear regime

β=β₀+γP (3)

The nonlinear coefficient γ can be defined in equation 2, in which c is the speed of light and A_{eff} is some effective area of the guided mode in the waveguide.

$$γ = \frac{ω}{c} \frac{{n}_{2}}{{A}_{eff}} \qquad ( 4 )$$

The effective area of the guided mode A_{eff} is defined in equation (5), the standard from used in the weak guiding regime, wherein eₜ is the transverse component of the electric field of the mode of the optical wave supported by the waveguide.

$${A}_{ef} = \frac{{( \int {\vert {e}_{t} \vert}^{2} d A )}^{2}}{{\int }_{nl} {\vert {e}_{t} \vert}^{4} d A} \qquad ( 5 )$$

The integration area of the integral in the denominator of equation (5) is over only the nonlinear region of the waveguide. Equation (5) illustrated a trend that as the fraction of the mode in the nonlinear region relative to waveguide increases, A_{eff} decreases and thus the γ increases.

The accuracy of equation (5) breaks down if the field does not resemble a plane wave in the nonlinear region. In particular, it is related to the presence of the significant longitudinal component of the electric field in high-index sub-wavelength waveguides. In the case of step-index optical fibers, the effective area of the guided mode has been determined to be described by equation (6).

$${A}_{eff} = \frac{{μ}_{0}}{{ɛ}_{0}} \frac{3 {\vert \int ( {E}^{} \times {{H}^{}}^{*} ) \cdot z d A \vert}^{2}}{{n}_{core}^{2} {\int }_{nl} {( 2 {\vert {E}^{->} \vert}^{4} + \vert {{E}^{->}}^{2} \vert )}^{2} d A} \qquad ( 6 )$$

Experimental results have been shown to give a better agreement with equation (6) instead of equation (5).

In the prior art calculating γ is based on finding overlap integrals with the mode profile and calculating an effective n₂ and A_{eff}. Note that the representation of the nonlinear coefficient γ as a product of several quantities is somewhat arbitrary. While it is common for γ to be factorized into the nonlinear coefficient n₂ and effective area A_{eff}, it is also possible to separate the group velocity or effective nonlinearity (or nonlinear susceptibility). However, it is not necessary for modeling nonlinear propagation since only γ enters into the propagation equation.

What is needed is to know how the wavenumber changes with power and therefore only the value of γ is important. Moreover, the value of γ can be calculated by using a definition given described in Equation (3). One can calculate the rate of the dispersion change that gives γ. Not only can such a procedure yield a relevant value, but it can also take advantage of the existing numerical approaches for dispersion calculation. The advantage of using effective areas stems from the fact that the dispersion properties and mode profiles can be analytically calculated for some simple waveguides, such as fibers consisting of a core and a cladding. Dispersion calculations can deal directly with arbitrary index distribution in the cross-section of a waveguide. A numerical approach can calculate the power dependence of the wavenumber.

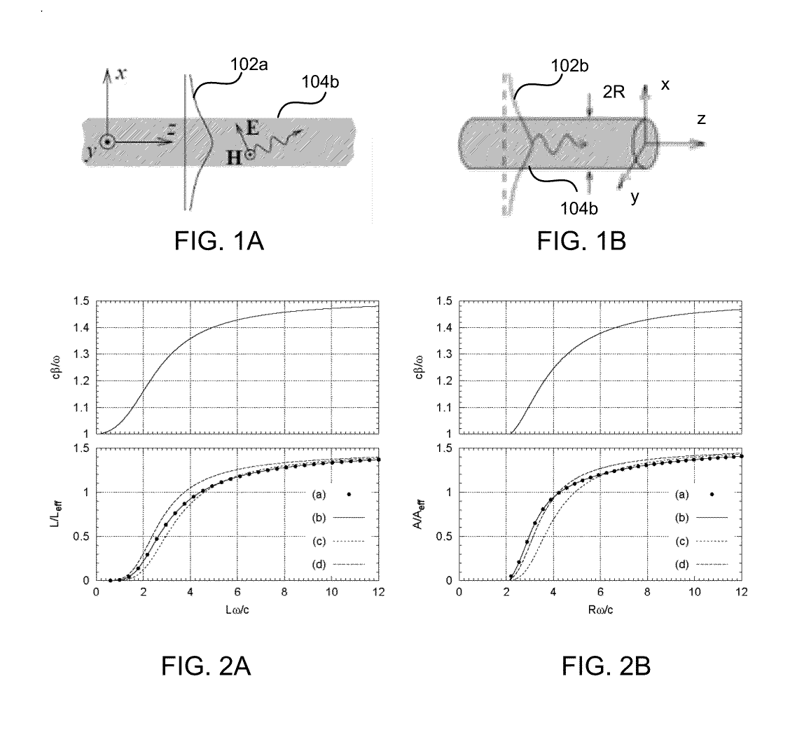

An exemplary embodiment of this approach may be used to describe a transverse-magnetic (TM) mode 102a of a slab waveguide 104a with a width L as illustrated in FIG. 1A and a transverse-magnetic (TM) mode 102b of a wire waveguide 104b with a radius R as illustrated in FIG. 2A. The slab 104a and the wire 104b have Kerr-type nonlinearity and are surrounded by vacuum. The choice of TM polarization allows us to include the contributions of both the transverse and longitudinal components of the electric field. The physical fields are assumed to be equal to twice the real part of their complex counterparts. In the exemplary embodiment of the slab, the electric and magnetic fields {Eₓ, E_{z}, H_{y}} are assumed to have ˜exp(−iωt+iβz) dependence. In the exemplary embodiment, our task is to calculate the nonlinear coefficient γ.

In the exemplary embodiment, we assume that the nonlinearity has non-resonant electronic origin (suitable for glass material) but other situations can be treated on the same footing. The nonlinear polarization in this situation can be written in equation (7).

\vec{p}^{nl}=∈₀ [symbol] [(\vec{E}·\vec{E}*)\vec{E}+1/2(\vec{E}·\vec{E})\vec{E}*] (7)

Wherein [symbol] =6χ₁₁₂₂, ∈₀ is the permittivity of free space, \vec{P}^{nl} is the non-linear polarization of the system, and \vec{E} is the electric field of the optical waves. The other non-zero terms of the fourth rank tensor χ are related to χ₁₁₂₂ by the symmetry of the system being evaluated. Equation (7) is a general form of equation (1). Rearranging equation (7) gives an effective power-dependent anisotropic susceptibility as described in equations (8) and (9).

$$\begin{matrix}{P}_{i}^{nl} = {ɛ}_{0} {\sum }_{j} {x}_{ij}^{eff} {E}_{j} & ( 8 ) \\ {χ}_{ij}^{eff} = \frac{𝒜}{2} [ ( {E}^{->} \cdot {{E}^{->}}^{*} ) {δ}_{ij} + ( {E}_{i} {E}_{j}^{*} + {E}_{i}^{*} {E}_{j} ) ] & ( 9 )\end{matrix}$$

Given the symmetry of the exemplary embodiment the components of Ψᵢⱼ^{eff} are described in equations (10)-(13).

$$\begin{matrix}{χ}_{xx}^{eff} = \frac{𝒜}{2} [ 3 {\vert {E}_{x} \vert}^{2} + {\vert {E}_{z} \vert}^{2} ] & ( 10 ) \\ {χ}_{zz}^{eff} = \frac{𝒜}{2} [ 3 {\vert {E}_{z} \vert}^{2} + {\vert {E}_{x} \vert}^{2} ] & ( 11 ) \\ {χ}_{xz}^{eff} = \frac{𝒜}{2} [ {E}_{x} {E}_{z}^{*} + {E}_{x}^{*} {E}_{z} ] & ( 12 ) \\ {χ}_{zx}^{eff} = {χ}_{xz}^{eff} & ( 13 )\end{matrix}$$

The knowledge of nonlinear susceptibility as described in equations (10)-(13) plays a key role in finding the nonlinear coefficient of the waveguide in which this material is used.

To model propagation we use the Maxwell equations as listed in equations (14)-(16).

$$\begin{matrix}iβ {E}_{x} - \frac{\partial {E}_{z}}{\partial x} = {iωμ}_{0} {H}_{y} & ( 14 ) \\ \frac{β}{ω} {H}_{y} = ɛ {E}_{x} + {P}_{x}^{nl} & ( 15 ) \\ \frac{i}{ω} \frac{\partial {H}_{y}}{\partial x} = ɛ {E}_{z} + {P}_{z}^{nl} & ( 16 )\end{matrix}$$

In which the nonlinear polarization Pᵢ^{nl} is described in equations (17) and (18).

Pₓ^{nl}=∈₀χₓₓ^{eff}Eₓ+∈₀χ_{xz}^{eff}E_{z} (17)

P_{z}^{nl}=∈₀χ_{zx}^{eff}Eₓ+∈₀χ_{zz}^{eff}E_{z} (18)

To find the components χᵢⱼ^{eff} we define the modal fields as described in equations (19).

$${E}_{x} = {E}_{0} {f}_{x} ( x ) , \\ {E}_{z} = {E}_{0} {f}_{z} ( x ) , \\ {H}_{y} = \sqrt{\frac{{ɛ}_{0}}{{μ}_{0}}} {E}_{0} {g}_{y} ( x ) \qquad ( 19 )$$

Where E₀ is an amplitude and fₓ(x), f_{z}(x), g_{y}(x) are dimensionless functions that describe the transverse profiles of the fields. The mode power P (per unit length along y), carried by mode 102a described by equation (19), is described by equations (20)-(21). L is the width of waveguide 104a.

$$\begin{matrix}P = \sqrt{\frac{{ɛ}_{0}}{{μ}_{0}}} {\vert {E}_{0} \vert}^{2} L η , & ( 20 ) \\ η = \frac{1}{L} {\int }_{- ∞}^{∞} [ {f}_{x} ( x ) {g}_{y}^{*} ( x ) + {f}_{x}^{*} ( x ) {g}_{y} ( x ) ] d x & ( 21 )\end{matrix}$$

Substituting the fields (19) into equations (10)-(13) gives us equations (22)-(24).

$$\begin{matrix}{χ}_{xx}^{eff} ( x ) = \frac{ξ}{2 η} [ 3 {\vert {f}_{x} ( x ) \vert}^{2} + {\vert {f}_{z} ( x ) \vert}^{2} ] & ( 22 ) \\ {χ}_{zz}^{eff} ( x ) = \frac{ξ}{2 η} [ 2 {\vert {f}_{z} ( x ) \vert}^{2} + {\vert {f}_{x} ( x ) \vert}^{2} ) ] & ( 23 ) \\ {χ}_{xz}^{eff} ( x ) = \frac{ξ}{2 η} [ {f}_{x} ( x ) {f}_{z}^{*} ( x ) + {f}_{x}^{*} ( x ) {f}_{z} ( x ) ] & ( 24 )\end{matrix}$$

Equation (25) describes dimensionless parameter ξ which is used in equations (22)-(24).

$$ξ = \frac{𝒜 P}{L} \sqrt{\frac{{μ}_{0}}{{ɛ}_{0}}} \qquad ( 25 )$$

In an exemplary embodiment the complex amplitudes Eₓ and E_{z} are shifted by π/2 and therefore, χ_{xz}^{eff}(x)=χ_{zx}^{eff} (x)=0, according to equation (24). Eliminating Eₓ and E_{z} from the Maxwell equations we obtain an equation for the y component of the magnetic vector field H_{y}(x) propagating electromagnetic field supported by the waveguide which is described in equation (26).

$$[ \frac{{c}^{2}}{{ω}^{2}} {\tilde{ɛ}}_{x} \frac{\partial }{\partial x} \frac{1}{{\tilde{ɛ}}_{z}} \frac{\partial }{\partial x} + {\tilde{ɛ}}_{x} ] {H}_{y} = {( \frac{c β}{ω} )}^{2} {H}_{y} \qquad ( 26 )$$

In which the relative nonlinear permittivities \tilde{∈}ₓ(x) and \tilde{∈}_{z}(x), are defined in equations (27).

$${\tilde{ɛ}}_{x} ( x ) = \frac{ɛ ( x )}{{ɛ}_{0}} + {χ}_{xx}^{eff} , {\tilde{ɛ}}_{z} ( x ) = \frac{ɛ ( x )}{{ɛ}_{0}} + {χ}_{zz}^{eff} \qquad ( 27 )$$

Equation (26) defines the modes for non-uniformly distributed anisotropic permittivity. Solving equation (26) gives the wavenumber β (or phase index cβ/ω) as well as the mode profiles. The parameter ξ determines how the permittivity changes with mode power P. The resultant change of β with P for small ξ gives γ as defined in equation (28).

$$γ = \frac{Δβ}{P} = \sqrt{\frac{{μ}_{0}}{{ɛ}_{0}}} \frac{𝒜ω}{Lc} \frac{c Δβ}{ωξ} = \frac{𝒜ω}{{ɛ}_{0} {Lc}^{2}} \frac{c Δβ}{ωξ} \qquad ( 28 )$$

Where Δβ=β−β₀ is the difference between the wavenumber with and without the nonlinear effect.

To find γ for a fixed ω, several steps are taken. First, the eigenvalue problem is solved in the linear regime. Second, the power-dependent anisotropic permittivity (27) is determined using the modal fields. Third, the eigenvalue problem for small ξ is solved and the new wavenumber is found. Fourth, the change of the wavenumber is divided by ξ and γ is obtained using (28).

To find the wavenumber determined by equation (26), the differential operators are approximated with finite differences. This gives an eigenvalue problem which we can be solved numerically using a variety methods including those listed in the LAPACK library.

Comparison with Other Methods

While equation (28) gives the required γ, it is useful to compare the result of the method described above with other approaches. For this we can extract the effective width L_{eff} defined by equation (4) from equation (28) using n₂=(3/8)\sqrt{μ₀/∈₀} [symbol] /n₀². Different approaches adopted to the slab 104a geometry and our notation gives equations (29)-(32):

$$\begin{matrix}\frac{1}{{L}_{eff}^{( a )}} = \frac{8 {n}_{0}^{2}}{3 L} \frac{c Δβ}{ωξ} & ( 29 ) \\ \frac{1}{{L}_{eff}^{( b )}} = \frac{{n}_{0}^{2}}{3 {S}_{2}^{2}} {\int }_{- L / 2}^{L / 2} 2 {( {\vert {f}_{x} \vert}^{2} + {\vert {f}_{z} \vert}^{2} )}^{2} + {\vert {f}_{x}^{2} + {f}_{z}^{2} \vert}^{2} d x & ( 30 ) \\ \frac{1}{{L}_{eff}^{( c )}} = \frac{1}{{S}_{1}^{2}} {\int }_{- L / 2}^{L / 2} {\vert {f}_{x} \vert}^{4} d x & ( 31 ) \\ \frac{1}{{L}_{eff}^{( d )}} = \frac{1}{{S}_{2}^{2}} {\int }_{- L / 2}^{L / 2} {( {f}_{x} {g}_{y}^{*} )}^{2} d x & ( 32 ) \\ {S}_{1} = {\int }_{- ∞}^{∞} {\vert {f}_{x} \vert}^{2} d x , {S}_{2} = {\int }_{- ∞}^{∞} {f}_{x} {g}_{y}^{*} d x & ( 33 )\end{matrix}$$

Equation (29) is the result of the method described herein. Equation (30) is the result of the vectorial approach. Equation (31) is the standard formula. Equation (32) is the modified standard formula. Note that the relation between the physical fields and their complex counterparts can differ by a factor of two in different studies. This does not affect the expressions for L_{eff} since the complex fields appear in the numerator and denominator with the same exponent.

The top graph of FIG. 2A shows the dispersion for the TM₀ mode 102a of the slab 104a with a linear refractive index of n₀=1.5 which is a typical value for silica waveguides. It was verified that the dispersion calculated by solving the eigenproblem (26) agrees with dispersion obtained by solving the standard characteristic transcendental equation for the slab 104a. The phase index cβ/ω grows from 1 to n₀ as Lω/c increases. There is no cut-off for the TM₀ mode 102a.

The bottom graph of FIG. 2A compares various L_{eff} as described in equations (29)-(33) by plotting L/L_{eff}. This ratio is also equal to the the ratio of the power-dependent change of the wavenumber for a mode 102a with power P propagating along the slab 104a with a width L and the change of the wavenumber for a plane wave with intensity I=P/L propagating in the same dielectric. The result for the method described herein L_{eff}^{(a)} agrees with the vectorial formula for L_{eff}^{(b)}. The results from the formulas for L_{eff}^{(c)} and L_{eff}^{(d)} give incorrect results. For weak waveguiding, Lω/c≲1, L/L_{eff}^{(b)} is smaller than the correct value L/L_{eff}^{(a,b)} by a factor of n₀², while L/L_{eff}^{(c)} is larger by the same factor. The standard formula L_{eff}^{(c)} works in the limit of low-index-contrast structures.

As illustrated in the bottom graph of FIG. 2B L/L_{eff} increases with Lω/c and reaches 1.5. Thus, the mode 102a with power P will have a 1.5 larger nonlinearity as compared to a plane wave with intensity P/L. The increasing nonlinearity with Lω/c is related to an increase in mode localization inside the slab 104a. The greater-than-unity L/L_{eff} is related to the strongly non-uniform mode distribution inside the slab where the fields are H_{y}, Eₓ˜cos(gy) with g=(ω/c)\sqrt{n₀²−(cβ/ω)²}. For Lω/c>>1, the fields behave like H_{y}, Eₓ˜cos(πy/L). This nonuniform distribution gives rise to the higher nonlinearity as compared to the case of a plane wave with intensity I=P/L. The asymptotic value L/L_{eff}→1.5 is not related to the slab index n₀=1.5. The same nonlinear enhancement for Lω/c>>1 was obtained for slabs with refractive indices that differ from n₀=1.5.

Let us now consider the TM₀₁ mode 102b of a dielectric wire 104b, as illustrated in FIG. 1B, with {E_{ρ}, E_{z}, H_{φ}} fields. The formulas derived above can be straightforwardly modified to treat this case in a cylindrical cooridinate system and are not repeated. For the numerial implementation, the discretized equation for E_{ρ}, similar to equation (26) for the slab 104a, was solved. The top graph of FIG. 2B shows the TM₀₁ dispersion has a cut-off at Rω/c≈2.405/\sqrt{n₀²−1}≈2.151. The bottom graph of FIG. 2B shows A/A_{eff} calculated using the four different approaches discussed above. For this, equations (29)-(33) were modified for the TM₀₁ mode 102b of the wire 104b. As with the result for the slab 104a, L_{eff}^{(a)} agrees with the vectorial formula for L_{eff}^{(b)}. The results from the formulas for L_{eff}^{(c)} and L_{eff}^{(d)} give incorrect results. The nonlinearity enhancement L/L_{eff} can be slightly greater than 1.5 for Rω/c>>1.

This is evidence that the nonlinear coefficient can be calculated using either dispersion modification as described above or by calculating using the vectorial form of the effective area.

The nonlinear Kerr coefficient γ can be estimated without the concept of the effective area. The direct calculation of γ not only gives it a value that enters into propagation equations (such as the nonlinear Schrödinger equation) but can be implemented by solvers that calculate dispersion properties for an arbitrary index distribution of a waveguide. The proposed methodology does not require any complicated derivations of the explicit expressions for γ. The common use of finite-element and finite-difference discretization schemes is such solvers is particularly suited for dealing with the non-uniform index distribution induced by Kerr nonlinearities. A simple solver based on the finite-difference scheme was described and implemented as an example. The calculated γ includes its frequency dependence and therefore is suitable for modeling nonlinear processes in a broad spectral range, as required, for example, for supercontinuum generation. Certainly, there is an exact correspondence between the nonlinear coefficients calculated using the overlap integrals and by solving the dispersion equations. While the use of overlap integrals to find the nonlinear coefficient originates from the analytical derivations within the framework of the perturbation approach, the direct solution of the dispersion equation does it numerically without lengthy analytical work. The presence of nonlinearity can also give rise to mode coupling that can be treated using the demonstrated approach. Besides Kerr nonlinearity, other types of nonlinearities can potentially be modeled, such as nonlinearities that are not instantaneous in time. It is expected that the demonstrated approach to calculate γ will simplify the design of various waveguiding structures with nonlinearities.

### Method

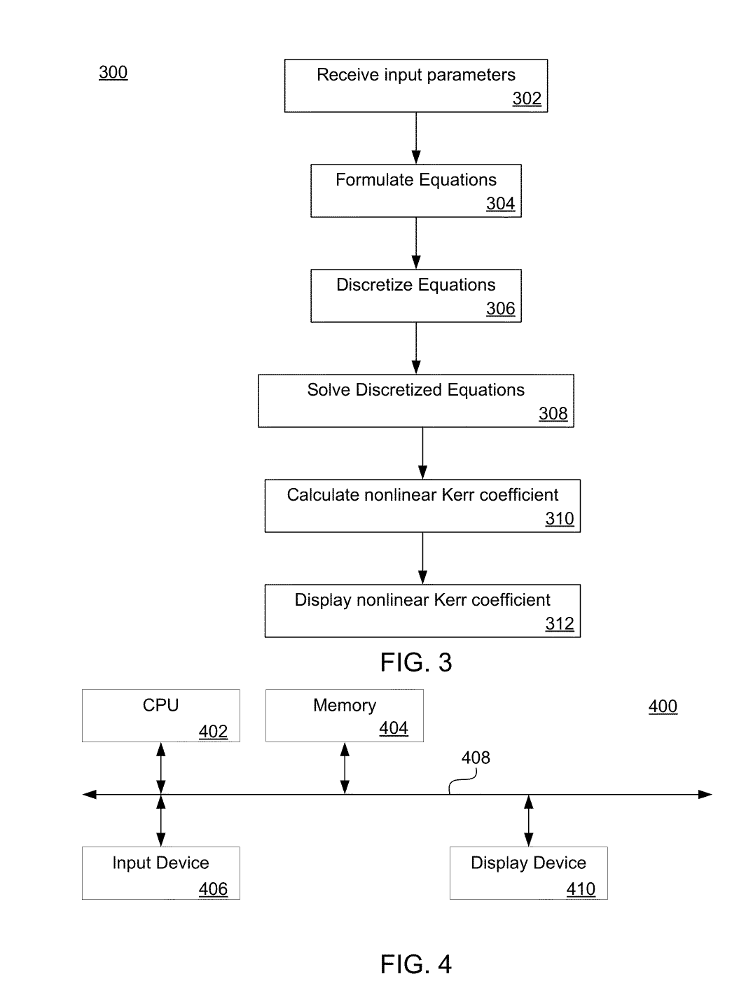

FIG. 3 is an illustration of a method 300 of calculating the Kerr coefficient. A receiving step 302 is to receive input parameters which describe the geometry of a waveguide and the material properties of the waveguide. The geometry input parameters may include height, width, length, radius, and/or axes of symmetry. These input parameters which define one or more areas and/or volumes of the waveguide. Each area and/or volume may have different material properties. Material properties input parameters may include linear refractive index, nonlinear susceptibility parameters, and/or other material properties.

A formulation step 304 is to formulate one or more differential and/or integral equations based on Maxwell's equations which describe the propagation of an electro-magnetic wave down a waveguide. These equations may be reduced to a single equation based on the symmetry of waveguide.

In a discretization step 306 the one or more equations are discretized. The discretization may involve converting the equations to difference equations. Alternatively, discretization techniques may use finite element methods to discretize the equations.

In a solving step 308 the eigenvalue solving technique may be used to solve the discretized equations for a set of electro-optical waves with a frequency ω and a wavenumber β in the non-linear regime and a wavenumber β₀ in the linear regime. This involves a first step of solving the discretized equations for β₀ and the fields in the linear regime. The power-dependent anisotropic permittivity is determined using the modal fields. An example of the power-dependent anisotropic permittivity is the relative nonlinear permittivities exemplified by equations (27) for a slab 104a. Thus, the fields from the linear regime, the refractive index in the discretized equations is modified to mimic the nonlinear change. After that, the modified discretized equations are solved for the wavenumber β in the non-linear regime. The solving step produces an eigenvalue which is related to the wavenumbers (β, β₀) as described in the equations from step 304. The power P of the electromagnetic wave is related to an integral of the square of the absolute value of the electromagnetic wave described by the eigenfunction produced during the solving step 308.

In a calculation step 310 the nonlinear Kerr coefficient is then calculated based on:

$$γ = \frac{β - {β}_{0}}{P}$$

In a display step 312 the nonlinear Kerr coefficient γ is then displayed.

FIG. 4 is an illustration of a device 400 that may be used to implement an exemplary embodiment. The device 400 may be a personal computer or a custom built computing device. The device 400 includes a central processing unit (CPU) 402 for executing instructions. The instructions may be encoded on a non-transitory computer readable medium. The non-transitory computer readable medium may include a recording medium, such as a hard disk, a floppy disk, an optical disk, a magnetic disk, a magneto-optical disk, a magnetic tape, and a non-volatile memory card, and a drive for driving the recording medium and recording information in it. The instructions and the data on which the instructions are performed may be stored in a memory 404. The device may include an input device 406 such as a keyboard, a mouse, touch panel, a stylus, and/or one or more buttons which provides a user with a method for providing information to the device. A bus 408 includes an address bus or a data bus and is connected to each unit in the configuration. The device 400 may include or be connected to a display device 410. The display device 410 can be used to display the state of the device and/or various input operations and processing results. The display device 410 can be formed of an LCD (liquid crystal display), a PDP (plasma display panel), an OLED (organic light-emitting diode), or the like, and can display images and/or text.

Aspects of exemplary embodiment can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of an exemplary embodiment.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A method for calculating a non-linear Kerr coefficient in a waveguide, comprising:
receiving input parameters which describe geometry of the waveguide and material properties of the waveguide;
formulating one or more or equations based on Maxwell's equations which represent propagation of an electro-magnetic wave down the waveguide based on the material properties of the waveguide and the geometry of the waveguide;
discretizing the one or more equations to produce one or more discretized equations;
solving the one or more discretized equations using an eigenvalue solving technique for a set of electro-optical waves with a frequency ω and a wavenumber β in the non-linear regime and a wavenumber β₀ in the linear regime;
wherein solving the one or more discretized equations produces an eigenvalue which is related to the wavenumbers (β, β₀) as described in the one or more or equations based on Maxwell's equations;
wherein a power P of the electromagnetic wave is related to an integral of a square of an absolute value of the electromagnetic wave described by an eigenfunction produced by solving the one or more discretized equations using the eigenvalue solving technique;
calculating a nonlinear Kerr coefficient γ, wherein γ is described by;
$$γ = \frac{β - {β}_{0}}{P}$$
outputting the nonlinear Kerr coefficient γ.

2. The method of claim 1 wherein the input parameters which describe the geometry are selected from: height; width; length; radius, and one or more axes of symmetry; and
the input parameters which describe the geometry define one or more areas or volumes of the waveguide;
each area or volume has different material properties;
the input parameters which describe material properties input parameters include linear refractive index, nonlinear susceptibility parameters;
the input parameters which describe material properties are functions which vary over the volume of the waveguide;

3. The method of claim 1 further comprising reducing the one or more or equations based on Maxwell's equations to one equation based on the symmetry of waveguide.

4. The method of claim 1, wherein the discretizing of the one or more equations based on Maxwell's equations includes converting the one or more equations to difference equations.

5. The method of claim 1, wherein the discretizing of the one or more equations based on Maxwell's equations includes converting the one or more equations to finite element equations.

6. The method of claim 1, wherein the one or more equations based on Maxwell's equations are differential equations.

7. The method of claim 1, wherein the one or more equations based on Maxwell's equations are integral equations.

8. The method of claim 1, wherein,
the solving of the one or more discretized equations comprises:
solving the one or more discretized equations in the linear regime for β₀ and an electric field of the electro-optical wave;
modifying a refractive index in the one or more discretized equations based on the electric field of the electro-optical wave; and
solving the modified one or more discretized equations in the non-linear regime for the wavenumber β; and
wherein the eigenfunction used to calculate the power P is based on solving the one or more discretized equations in the linear regime.

9. The method of claim 8, wherein the refractive index is modified by calculating the power-dependent anisotropic permittivity using modal fields determined from the electric filed of the electro-optical wave.

10. A computer readable medium for calculating a non-linear Kerr coefficient in a waveguide, comprising:
receiving input parameters which describe geometry of the waveguide and material properties of the waveguide;
formulating one or more or equations based on Maxwell's equations which represent propagation of an electro-magnetic wave down the waveguide based on the material properties of the waveguide and the geometry of the waveguide;
discretizing the one or more equations to produce one or more discretized equations;
solving the one or more discretized equations using an eigenvalue solving technique for a set of electro-optical waves with a frequency ω and a wavenumber β in the non-linear regime and a wavenumber β₀ in the linear regime;
wherein solving the one or more discretized equations produces an eigenvalue which is related to the wavenumbers (β, β₀) as described in the one or more or equations based on Maxwell's equations;
wherein a power P of the electromagnetic wave is related to an integral of a square of an absolute value of the electromagnetic wave described by an eigenfunction produced by solving the one or more discretized equations using an eigenvalue solving technique;
calculating a nonlinear Kerr coefficient γ, wherein γ is described by;
$$γ = \frac{β - {β}_{0}}{P}$$
outputting the nonlinear Kerr coefficient γ.
